(19) United States
(12) Patent Application Publication
(10) Pub. No.: US 2004/0002390 A1
(43) Pub. Date: Jan. 1, 2004

(54) Shaft with coupling and a method of forming thereof

(76) Inventor: Nikolai Pavski, Ontario (CA)

Correspondence Address: Robin W Asher, Clark Hill, 500 Woodward Avenue, Suite 3500, Detroit, MI, 48226-3435, US

(21) Appl. No.: 10/363,175

(22) PCT Filed: Apr. 25, 2002
(86) PCT No.: PCT/CA02/00604

(51) Int. Cl. F16D 3/16

(52) U.S. Cl. 464/134

(57) ABSTRACT

A method for forming a coupling structure (40, 140) on an end of a drive shaft and a drive shaft (10) made by the method. The method includes the steps of providing a tubular shaft (22, 122) having an open end. Forming a driving configuration at the end. Closing the open end at a point spaced from the open end. Casting a coupling structure (40, 140) on the closed end in driving engagement with the shaft (22, 122).

### FIELD OF INVENTION

This invention relates to a method for manufacturing a drive shaft with a drive coupling thereon. In particular, this invention relates to a method for forming a coupling on an end of a power transmission shaft and a power transmission shaft made by the method.

### BACKGROUND OF INVENTION

Power transmission shafts, such as drive shafts, are commonly fitted with a yoke. The yoke is part of a universal type of coupling. The yoke is manufactured separately from the power transmission shaft. The yoke will have a shaft portion that is inserted into the end of the power transmission shaft and then circumferentially welded in place. The shaft is then machined to rotationally balance the shaft. Examples of power transmission shafts having a welded yoke include U.S. Pat. Nos. 5,230,658; 5,716,276; and publication no. WO 98/48186.

The prior art shafts produce suitable results. However, improvements can be had in providing the yoke assembly directly onto the end of the shaft.

### SUMMARY OF INVENTION

The disadvantages of the prior art may be overcome by providing a method for forming a yoke structure directly on an end of a power transmission shaft.

It is desirable to provide a method for forming a yoke structure on the end of shaft which reduces manufacturing steps, improves a rotational balance and reduces weight of the power transmission shaft.

According to one aspect of the invention, there is provided a method including the steps of a tubular shaft having an open end. Forming a driving configuration at the end. Closing the open end with a cap. Casting a coupling structure on the closed end in driving engagement with the shaft.

According to another aspect of the invention, there is provided a drive shaft formed by the method of the present invention.

### DESCRIPTION OF THE DRAWINGS

In drawing which illustrate embodiments of the present invention,

FIG. 1 is a perspective view of a power transmission shaft having a coupling structure formed thereon according to the present invention;

FIG. 2 is a perspective view of a power transmission shaft in an initial stage;

FIG. 3 is a perspective view of a power transmission shaft in an intermediate stage;

FIG. 4 is a perspective view of a cap according to the present invention;

FIG. 5 is a side elevational view of the cap of FIG. 4; and

FIG. 6 is a side sectional view of a second embodiment of the present invention.

### DESCRIPTION OF THE PREFERRED EMBODIMENT

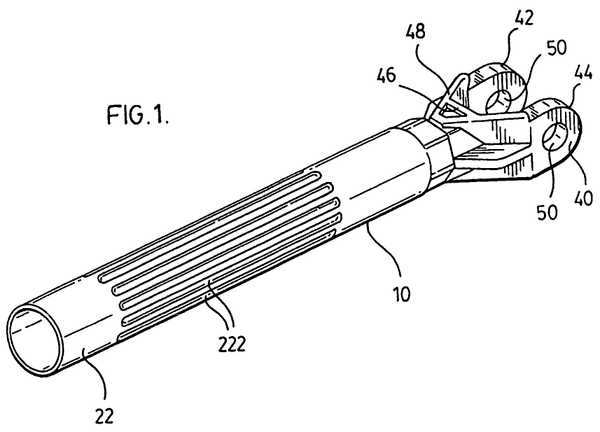

Referring to FIG. 1, a power transmission shaft 10 embodying the present invention is illustrated. The power transmission shaft 10 is preferably a drive shaft for a motor vehicle. The drive shaft 10 can be either a conventional one piece drive shaft that has a yoke or coupling structure on each end thereof or a conventional two piece drive shaft connect by a slip joint. The yoke or coupling structure is provided on opposite ends of the shaft components of the drive shaft.

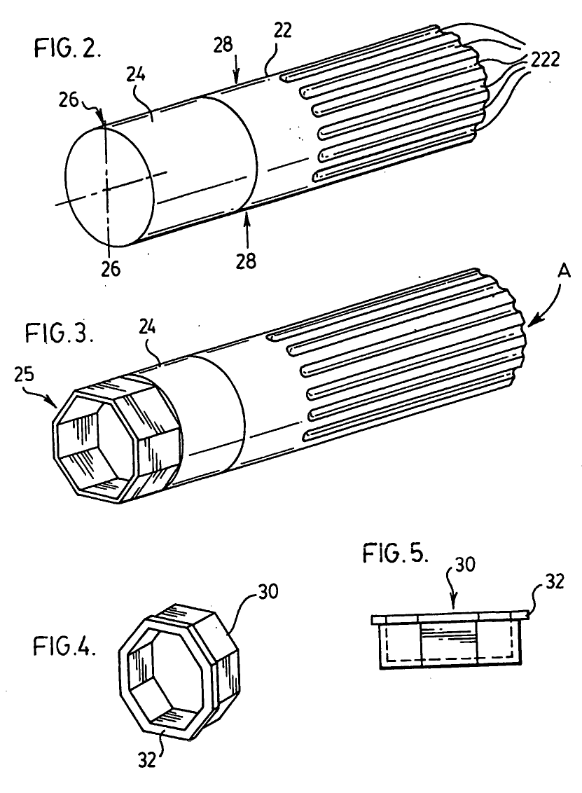

Referring to FIG. 2, a tubular shaft 20 is provided. Preferably, the shaft 20 is steel. However, it is also contemplated that aluminum tubing could be employed. The tubular shaft 20 is optionally provided with a series of circumferentially spaced longitudinally extending splines 222. An end 24 has a yoke diameter 26. Yoke diameter 26 is slightly less than the shaft diameter 28. Tubular shaft 20 is manufactured in accordance with known methods.

Referring to FIG. 3, end 24 undergoes a forming operation to form a driving configuration in the form of a non-circular cross-sectional configuration 25. In the preferred embodiment, the non-circular cross-sectional configuration is octagonal and formed by a swaging operation. However, it is readily understood that other non-circular shapes, such as hexagonal, rectangular would provide suitable results. Additionally other forming operations such as stamping could also be utilized with similar results.

Referring to FIGS. 3 and 4, a cap 30 of the present invention is illustrated. The cap 30 is preferably made of aluminum. The cap 30 is cup shaped having an outline complementary with the non-circular cross-sectional configuration 25 of end 24. The cap 30 is sized to frictionally fit within driving configuration 25. The cap 30 can be inserted from the near end wherein the lip 32 will engage the end edge of the shaft 22. Optionally, cap 30 has a lip 32 that will fit within the shaft 22 when the cap 30 is inserted from the distal end thereof in the direction of arrow A. Cap 30 will close the open end of the shaft 22 at the near end or at a point spaced from the near end of the shaft 22.

With the end 24 closed, the end 24 of shaft 22 is placed in a casting mold. The casting mold has a cavity complementary to the shape of the coupling or yoke structure 40. A yoke structure 40 is then cast directly onto the end 24 of the shaft 22.

Yoke structure 40 generally has two legs 42 and 44 extending from a bight portion 46. Optionally, ribs 48 are provided to improve structural strength of the yoke structure 40.

The next step for processing the power transmission shaft 10 of the present invention is to machine or bore transversely extending apertures 50 in each of the legs 42, 44.

The present invention has been described in terms of casting a single yoke structure 40 on an end of a shaft 22. However, it is readily apparent to one skilled in the art that multiple yoke structures could be cast on ends of multiple shafts by designing a multi-cavity mold. Additionally, on a single drive shaft, yoke structures on opposite ends thereof could be cast simultaneously.

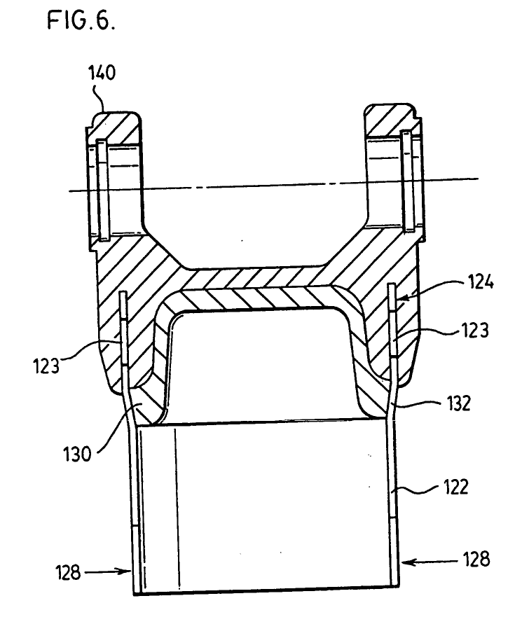

Referring to FIG. 6, a second embodiment of the present invention is illustrated. The second embodiment is particularly useful for single tube drive shafts. In single tube drive shafts, it not convenient to insert an end cap at both ends if the end cap is inserted from the opposite end. The end 124 of tube 122 is first formed into a driving configuration by swaging the end 124 to expand the diameter thereof and forming at least one transverse aperture 123 therein. Preferably 2 or more apertures 123 are formed in the end 124. As is apparent to those skilled in the art, the apertures 123 can be formed by any conventional process, such as piercing, lancing, drilling, laser cutting, etc., either before or after the swaging step.

A cup shaped cap 130 is inserted from the near or swaged end 124 into the tube 122. The rim 132 of the cap 130 has an outer diameter that is less than the diameter of end 124 but greater than the original diameter 128 of tube 122. The rim 132 will frictionally engage the inside surface of the tube 122 preferably at the transition between diameters to seal the end of the tube 122. Once inserted, the cap 130 closes the end of the tube 122 and the yoke structure 140 can be cast thereon. The cap 130 limits the extent to which the yoke structure 140 extends into the end 124. As is apparent, the cast material will flow between the inside and outside of the tube 122 through aperture 123. Once solidified, the yoke structure 140 will have a dowel structure to provide a driving connection with the tube 122.

While the invention has been described in connection with what is presently considered to be the most practical and preferred embodiment, it is understood that the invention is not limited to the disclosed embodiments but, on the contrary, it intended to cover various modifications in the arrangements as defined in the attached claim.

What is claimed is:

1. A method of forming a coupling structure on an end of a power transmission shaft, the method comprising steps of:
providing a tubular shaft having an open end;
forming a driving configuration at said end;
closing said open end; and
casting a coupling structure on said closed end in driving engagement with said shaft.

2. A method as claimed in claim 1 wherein said driving configuration is non-circular.

3. A method as claimed in claim 2 wherein said driving configuration is hexagonal.

4. A method as claimed in claim 3 wherein said forming step is swaging.

5. A method as claimed in claim 4 wherein said closing step includes positioning a cap in said shaft to engage said driving configuration.

6. A method as claimed in claim 5 wherein said positioning includes inserting the cap in the shaft in frictionally engagement with the driving configuration.

7. A method as claimed in claim 1 wherein said forming step comprises expanding an end region of said shaft and providing at least one transverse aperture in said expanded end region.

8. A method as claimed in claim 7 wherein said casting step includes flowing cast material through said at least one transverse aperture.

9. A method as claimed in claim 8 wherein said closing step includes positioning a cap in said shaft in frictional engagement with the driving configuration.

10. A method as claimed in claim 9 wherein said positioning includes inserting the cap in the shaft from a near end thereof.

11. A method as claimed in claim 10 wherein said expanding step is swaging.

12. A power transmission shaft having a coupling structure cast on an end thereof in driving connection with said shaft.

13. A power transmission shaft as claimed in claim 12 further comprising a cap limiting an extent that said coupling structure extends into said shaft as said coupling structure is cast thereon.

14. A power transmission shaft as claimed in claim 13 wherein said driving connection is a non-circular configuration at said end.

15. A power transmission shaft as claimed in claim 14 wherein said non-circular configuration is hexagonal.

16. A power transmission shaft as claimed in claim 15 wherein said cap engages a transition region between the non-circular configuration and the shaft.

17. A power transmission shaft as claimed in claim 15 wherein said cap engages a near end of said shaft.

18. A power transmission shaft as claimed in claim 17 wherein said coupling structure is a yoke.

19. A power transmission shaft as claimed in claim 13 wherein said driving connection is a circular configuration having at least one transverse aperture therein and said coupling structure extends through said at least one aperture.

20. A power transmission shaft as claimed in claim 19 wherein said circular configuration has a diameter greater than a diameter of said shaft.

21. A power transmission shaft as claimed in claim 20 wherein said cap engages a transition region between the diameter of the circular configuration and the diameter of the shaft.

22. A power transmission shaft as claimed in claim 21 wherein said coupling structure is a yoke.
